(19) United States
(12) Patent Application Publication
(10) Pub. No.: US 2011/0286749 A1
(43) Pub. Date: Nov. 24, 2011

(54) RELIABLE COMMUNICATIONS VIA FREE SPACE OPTICS USING MULTIPLE DIVERGENCE BEAMS

(76) Inventor: PETER SCHOON, Orono, MN (US)

(21) Appl. No.: 12/782,058

(22) Filed: May 18, 2010

(51) Int. Cl. H04B 10/10

(52) U.S. Cl. 398/128

(57) ABSTRACT

A method of enhancing FSO (Free Space Optics) communications is disclosed including using dual or multiple beam divergence rates to increase the reliability of detection of optically received signals by transmitting the same information signal via multiple transmitters, each transmitter transmitting the information signal with a divergence rate different from the other transmitters. Using multiple divergence rates provides sufficient beam and/or signal density for reliable detection at the receiving end while also maintaining beam alignment. Active tracking of beams is improved by reducing operating frequency thresholds, and thus, system cost, needed for tracking the beam.

### TECHNICAL FIELD

This application relates generally to Free Space Optics (FSO). More specifically, this application relates to a method and apparatus for reliable transmission of signals via FSO-based communication systems using multiple divergence rate signal beams.

### SUMMARY

In aspects of present disclosure, a Free Space Optical (FSO) transceiver is disclosed including a first transmitter configured to transmit a beam at a first divergence rate, and a second transmitter configured to transmit the beam at a second different divergence rate.

In further aspects of the present disclosure, a method of transmitting FSO signals is disclosed. The method includes setting a first divergence rate of a first transmitter in a first FSO transceiver and setting a second divergence rate of a second transmitter in the first FSO transceiver, wherein the second divergence rate is different from the first divergence rate. The method further includes transmitting an optical beam simultaneously by the first and the second transmitters.

### BRIEF DESCRIPTION OF THE DRAWINGS

The drawings, when considered in connection with the following description, are presented for the purpose of facilitating an understanding of the subject matter sought to be protected.

FIG. 1A is an example environment where an FSO-based communication system is deployed between two buildings;

FIG. 1B is another example environment where an FSO-based communication system is sequentially deployed between multiple buildings providing a single path from a first to a last building;

FIG. 1C is yet another example environment where an FSO-based communication system is deployed between multiple buildings providing multiple paths from each building to others;

FIG. 2A shows an example pair of transceivers for FSO communications;

FIG. 2B shows an example beam divergence sent from a transmitter to a receiver;

FIG. 2C shows an example beam tracking and adjustment system for FSO communications;

FIG. 3A shows example dual divergence signal beams and the corresponding receiver-side signal coverage;

FIG. 3B shows example dual divergence signal beams transmitted by a first FSO transceiver and received by a second FSO transceiver;

FIG. 3C shows the example dual divergence signal beams of FIG. 3B transmitted in the reverse direction by the second FSO transceiver and received by the first FSO transceiver;

FIG. 4A shows example multiple divergence signal beams transmitted by a first FSO transceiver and the corresponding signal coverage at a second FSO transceiver;

FIG. 4B shows an example projection of multiple divergence signal beams at a receiving end FSO transceiver; and

FIG. 5 is a flow diagram showing an example FSO signal transmission routine using multiple divergence rates.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references dual divergence beam, it will be appreciated that the disclosure may be used for other number of beams and is not limited solely to dual divergence beams.

Briefly described, a method of enhancing FSO communications is disclosed including using dual or multiple beam divergence to increase the reliability of detection of optically received signals by transmitting the same information signal via multiple transmitters, each transmitter transmitting the information signal with a divergence rate different from the other transmitters. For transmission and receipt of optical signals, the optical elements, such as lenses, at transmitting and receiving ends are substantially aligned so that a transmitted beam is reliably received and detected at the receiving end. The alignment between the transmitting and receiving ends may be distorted due to a number of factors, such as movement of tall buildings, further described below. To maintain reliable signal communications, signal beams may be transmitted at a relatively high divergence rate, for example, 2-6 milli-radians (mrad), so that at the receiving end a large enough beam diameter is delivered for detection. Active tracking technologies, further described below, may also be employed to adjust the direction of the transmission of the signal beam. Multiple divergence rate beams increases at least the effectiveness and reliability of both techniques (that is, high beam divergence and active tracking) for reliable signal detection mentioned above.

Optical signals may be used to carry information signals, similarly to radio waves. Optical signals may be transmitted through separate optical media, such as fiber optics, or through air or space with no separate media. The latter is known as Free Space Optics or FSO. FSO-based form of delivering communications services has compelling economic and technical advantages. FSO communication systems can be installed relatively quickly and carry full-duplex (simultaneous bidirectional) data cost-effectively at gigabit-per-second rates over metropolitan distances of a few city blocks to a few kilometers. FSO systems typically need less than a fifth the capital outlay of comparable ground-based fiber-optic technologies. Moreover, installing an FSO system can be done in a matter of days on building rooftops, compared to months or years for optic fiber, and even faster if the FSO equipment are placed in offices behind windows instead of on rooftops. Using FSO, a service provider can be generating revenue while a fiber-based competitor is still seeking municipal approval to dig up a street to lay its cables.

FSO communication systems may be used in many circumstances, for example, Metro network extensions. Communication carriers can deploy FSO to extend existing metropolitan-area fiber rings, to connect new networks, and, in their core infrastructure, to complete Sonet rings.

Another application of FSO systems is the so-called “last-mile” access, where users need access to the Internet or other network at the far ends of the network's reach. FSO may be used in high-speed links that connect end-users with Internet service providers or other networks. FSO may also be used to bypass local-loop systems to provide businesses with high-speed connections.

Yet another application of FSO systems is enterprise connectivity. The ease with which FSO links can be installed makes them a natural for interconnecting local-area network segments that are housed in buildings separated by public streets or other right-of-way property.

Still another application of FSO systems is fiber redundancy or backup in case of fiber optic failure. FSO systems may be deployed in redundant links to back up fiber in place of a second fiber link.

Another application of FSO is Backhaul. FSO may be used to carry cellular telephone traffic from antenna towers back to facilities wired into the public switched telephone network.

Another application FSO systems is service acceleration. FSO may be used to provide instant service to fiber-optic customers while their fiber infrastructure is being laid.

Until recently, the technology was used primarily for enterprise connectivity. It shows up mainly in local-area networks spanning multiple buildings, where right-of-way was an obstacle to leasing copper lines or fiber-optic cabling.

Generally, carrier-class service delivery is expected to be at about 99.999% (“five nines” level) availability and reliability. Carrier-class service typically delivers only one bad bit out of every 10 billion it carries, and statistically is out of service no more than 5 minutes and 15 seconds a year. For the rest of the 12-month period, the network is expected to be available.

For free-space optics, challenges to achieving this level of reliability performance take the shape of environmental phenomena that vary widely from one micrometeorological area to another. These environmental phenomena include scintillation, scattering, beam spread, and beam wander.

Scintillation is the temporal and spatial variations in light intensity caused by atmospheric turbulence. Such turbulence may be caused by wind and temperature gradients that create pockets of air with rapidly varying densities and therefore fast-changing indices of optical refraction. These air pockets act like prisms and lenses with time-varying properties. Their action is readily observed in the twinkling of stars in the night sky and the shimmering of the horizon on a hot day.

FSO communications systems deal with scintillation by sending the same information from several separate laser transmitters. These transmitters may be mounted in the same housing, or link head, but separated from one another by some distance, for example, about 200 mm. It is unlikely that in traveling to the receiver, all the parallel beams will encounter the same pocket of turbulence since these scintillation pockets are usually quite small as compared with transmission distances. Most probably, at least one of the beams will arrive at the target node with adequate strength to be properly received. This approach is called spatial diversity, because it exploits multiple regions of space. In addition, it is highly effective in overcoming any scintillation that may occur near windows. In conjunction with a design that uses multiple and spatially separated large-aperture receive lenses, this multi-beam approach is even more effective.

Optical signal attenuation due to scattering of light when passing through water particles suspended in fog, more formally known as Mie scattering, is largely a matter of boosting the transmitted power, although spatial diversity also helps to some extent. In areas with frequent heavy fogs, it is often necessary to choose 1550-nm wavelength lasers because of the higher power permitted at that wavelength. Also, there is some evidence that Mie scattering is slightly lower at 1550 nm than at 850 nm, due to the longer wavelength potentially missing some of the water particles. However, scattering may be independent of the wavelength under heavy fog conditions. Nevertheless, to ensure carrier-class availability for a single FSO link in most non-desert environments, the link length may be generally limited to about 200-500 meters.

Free-space optics systems, when deployed in conjunction with a traditional network, such as fiber optics, copper wires, and the like, may be engineered to provide the high availability needed by communication service carriers. In one embodiment, FSO may be deployed by limiting optical link length (the distance between FSO transmitter and receiver) in accordance with known local weather patterns. For example, field trials with a number of carriers around the world may be conducted to ascertain service availability/reliability over a span of time at a challenging time of the year for worst-case weather patterns.

Other atmospheric disturbances, like snow and especially rain, are typically less of a problem for free-space optics than fog.

One of the common difficulties that arises when deploying free-space optics links on tall buildings or towers is sway due to wind or seismic activity. Both storms and earthquakes can cause buildings to move enough to affect beam angle when aiming/targeting. Generally, two complementary techniques are used to compensate for building movements: beam divergence and active tracking. These approaches are further described below.

In the beam divergence technique, the transmitted light beam is purposely allowed to diverge, or spread, so that by the time it arrives at the receiver (receiving link head), the beam forms a fairly large optical cone the projection of which at the receiving end is a wider circle relative to the beam circumference at the transmitting end. Depending on product design, the typical FSO light beam subtends an angle of 3-6 mrads (10-20 minutes of arc) and will have a diameter of about 3-6 meters after traveling 1 km. If the receiver is initially positioned at the center of the beam, divergence alone can deal with many perturbations. This inexpensive approach to maintaining system alignment has been used quite successfully by FSO vendors for several years.

If, however, the link heads (transceivers) are mounted on the tops of extremely tall buildings or towers, an active tracking system may be needed to maintain beam alignment between transmitter and sender. More sophisticated and costly than beam divergence, active tracking is typically based on movable mirrors that control the direction in which the beams are launched. A feedback mechanism continuously adjusts the mirrors so that the beams stay on target. These closed-loop systems are also valuable for high-speed links that span long distances, on the order of a few kilometers. Over such longer transmission distances, beam divergence alone may not be sufficient to maintain beam alignment. By its very nature, beam divergence reduces the beam power density, reducing reliability of detected data and increasing probability of transmission errors mainly due to decreased signal/Noise (S/N) ratio.

Another source of beam misalignment and thus errors in communication is beam wander which, arises when turbulent eddies (fluid currents) bigger than the beam diameter cause slow, but large displacements of the transmitted beam. Beam wander typically occur over wide-open spaces, such as deserts over long distances. When it does occur, however, the wandering beam can completely miss its target receiver. Like building sway, beam wander may be handled by active tracking. To help alignment of optical beam, active tracking may be operated at above certain frequency thresholds depending on frequency of building sway or shake, weather conditions, transmission length, beam or transmission power, and the like. Increased frequency of active tracking increases the cost of the FSO system significantly. Operating at lower than necessary active tracking frequencies reduces effectiveness and reliability of active tracking.

Multiple (or dual) divergence of optical beams improves the effectiveness and reliability of both techniques (that is, beam divergence and active tracking) for building motion compensation. Briefly, beam divergence technique is improved by using multiple divergence rates to provide sufficient beam and/or signal density while also maintaining alignment, and active tracking technique is improved by reducing operating frequency thresholds, and thus, cost, needed for tracking the beam. These improvements are further described below.

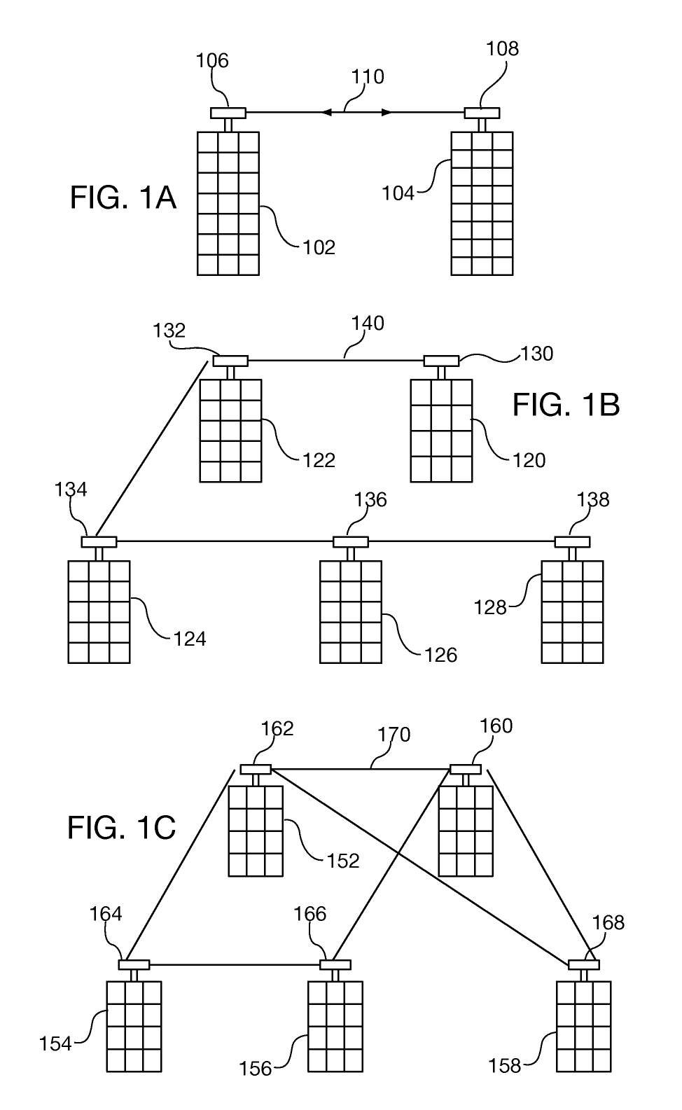

FIG. 1A is an example environment where an FSO-based communication system is deployed between two buildings. In one embodiment, FSO transceivers 106 and 108 are deployed on top of buildings 102 and 104, respectively, transmitting information optical beam 110 between buildings 102 and 104. This configuration may be used to supply an end building in a greater enterprise campus with network and communication services when the end building is not directly coupled with traditional wired networks. As noted above, if buildings 102 and 104 are tall, sway due to wind, earthquake tremors, and the like may interrupt beam 110 due to misalignment of transceivers 106 and 108.

FIG. 1B is another example environment where an FSO-based communication system is sequentially deployed between multiple buildings providing a single path from a first to a last building. In one embodiment, FSO transceivers 130-138 are deployed substantially on top of buildings 120-128, respectively, providing a single-path sequential communications between buildings 130-138. In another embodiment, FSO transceivers 130-138 are deployed behind office windows inside the buildings. In these embodiments, if a building transceiver fails, the following buildings are cut-off from communications coming through the failed transceiver. Hence in this linear configuration a single point of failure causes service failure to the buildings following the point of failure.

FIG. 1C is yet another example environment where an FSO-based communication system is deployed between multiple buildings providing multiple paths from each building to others. In one embodiment, FSO transceivers 160-168 are deployed substantially on top of buildings 150-158, respectively, providing a multiple-path communications between buildings 150-158. In another embodiment, FSO transceivers 160-168 are deployed behind office windows inside the buildings. In these embodiments, if a building transceiver fails, the following buildings are not cut-off from communications coming through the failed transceiver. In this graph configuration a single point of failure does not cause service failure to any of the buildings following the point of failure, because all buildings have more than one path to access the network.

In each of the above configurations, multiple beam divergence can enhance FSO communication network reliability.

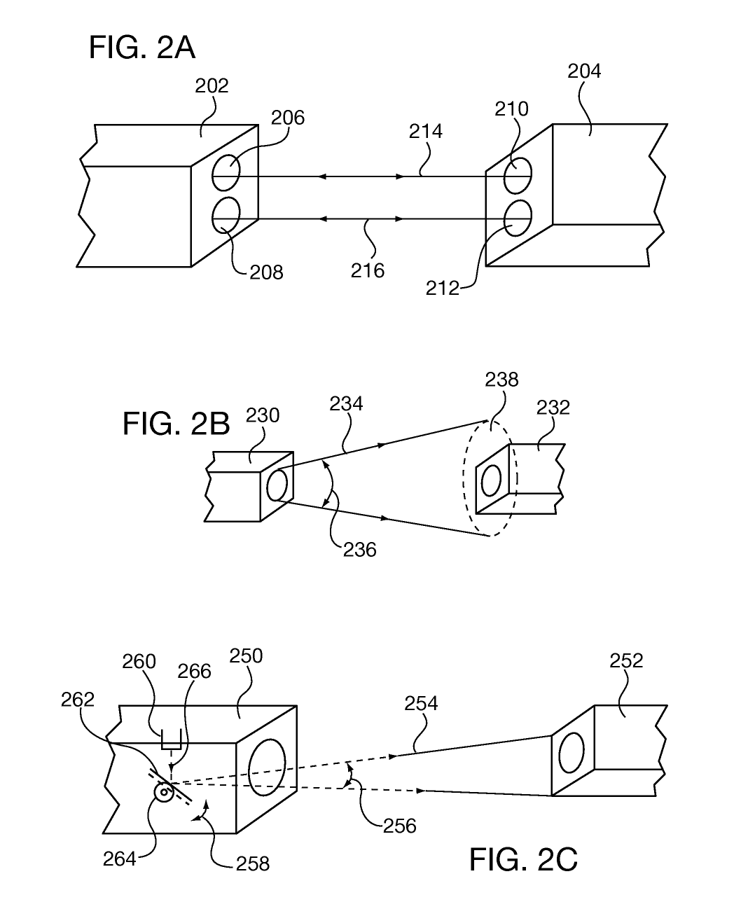

FIG. 2A shows an example pair of transceivers for FSO communications. Transceivers 202 and 204 transmit and receive beams 214 and 216 via transmitters 206 and 212, and receivers 208 and 210. Transceivers 202 and 204 may include two or more transmitters and receivers. Each transmitter may be configured to transmit an optical beam with a divergence rate or spread different from other transmitters in the transceiver.

FIG. 2B shows an example beam divergence sent from a transmitter to a receiver. Transmitter 230 transmits beam 234 with a spread or divergence rate 236 to receiver 232. A size of projection 238 of beam 234 depends on spread 236 and a distance between transmitter 230 and receiver 232. The larger the divergence rate or spread of the optical beam, the larger the projection area at the receiver, and the lower the beam density. By adjusting spread 236, building sway may be compensated for by providing a larger projection area for receiver 238 to detect. For a large enough spread 236, if receiver 238 is focused substantially on the center of projection 238, then a misalignment between transmitter 230 and receiver 232 due to building sway, may cause the focus of receiver 238 to move away from the center of projection 238, but still be within the inside perimeter of projection 238, and thus, still receive beam 234.

FIG. 2C shows an example beam tracking and adjustment system for FSO communications. In one embodiment, a tracking FSO transceiver 250 may include a source of beam signal 260, projecting internal beam 266 to mirror 262 mounted on pivot point 264, which may be rotated through an angle 258. External beam 254 with spread 256 is transmitted in the direction determined by mirror 262. By adjusting angle 258 of mirror 262, direction of external beam 254 is adjusted, while spread 256 stays the same. By moving the mirror 262 around pivot 264 at some frequency close to the frequency of the building sway movement, external beam 254 may be targeted at and maintained on receiver 252 by compensating the building movement in the opposite direction.

In other various embodiments, other mechanisms may be used to effect a change in the direction of external beam 254. For example, internal beam 266 may be switched at appropriate frequency to fixed reflective surfaces such as mirrors, or directed through optic fibers along particular fixed angles 258 to set the direction of external beam 254. In these embodiments, no mechanical movement of a pivoted mirror is necessary and direction change is effected via switching.

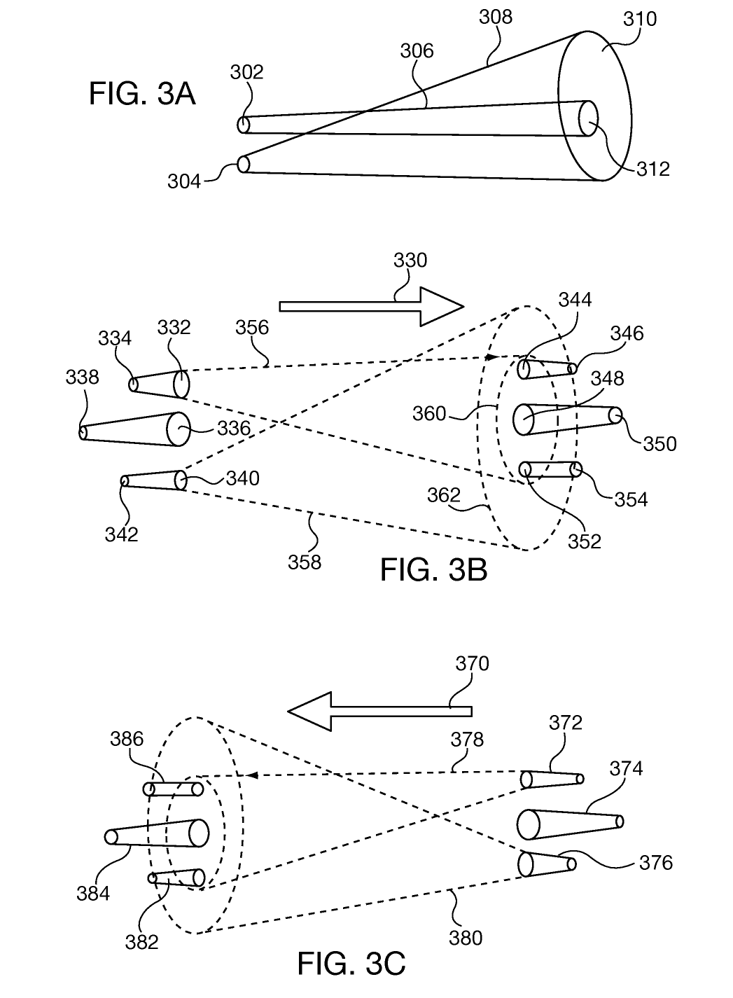

FIG. 3A shows example dual divergence signal beams and the corresponding receiver-side signal coverage. Two transmitters 302 and 304 transmit two beams 306 and 308 with different respective divergence rates, creating projection areas 312 and 310, respectively. In one embodiment two transmitters with respective divergence rates are used. In other various embodiments, multiple transmitters (more than two) are used to project different corresponding projection areas at receiver end. The projection areas are generally different in size and overlapping to provide unbroken transmission in case alignment between transmitter and receiver is disrupted.

FIG. 3B shows example dual divergence signal beams transmitted by a first FSO transceiver and received by a second FSO transceiver. Generally, transceivers include Light Emitting Diodes (LEDs) 334 and 342 at the first FSO transceiver for transmitting optical beams 356 and 358 at different divergence rates resulting in different projection areas 360, 362 at the second FSO transceiver (receiving side in this figure). The second FSO transceiver may also transmit beams simultaneously from LEDs 346 and 354 to be received by the first FSO transceiver. The transmitters also include beam spreading lenses 332, 340, 344, and 352 for focusing optical beams 356 and 358 at a predetermined divergence rate. Receivers 338 and 350 include concentrating lenses 336 and 348 for collecting light from optical beams 356 and 358 at the receiver sides.

FIG. 3C shows the example dual divergence signal beams of FIG. 3B transmitted in the reverse direction by the second FSO transceiver and received by the first FSO transceiver. Similarly to FIG. 3B, transmitters 372, 376, 386 and 382 may transmit beams 378 and 380 to be received by receivers 384 and 374.

As depicted in FIGS. 3A-3C, using multiple divergence rates to provide overlapping projection areas at the receiving end, sufficient beam and/or signal coverage may be provided while increasing beam density and also maintaining the receiver within the projected beam area to receive and concentrate the beam. Increased beam density increases S/N ratio, enabling more reliable signal communication and detection.

In case active tracking is used to compensate for building sway, multiple (or dual) transmission divergence rates may reduce needed operating frequency for tracking the beam because the beam and/or the receiver can move through a relatively larger area without losing contact with the signal, while still remaining within the overlapping beam projection areas generated based on the higher divergence rates. This approach may significantly reduce the cost and complexity, and increase the reliability of FSO systems.

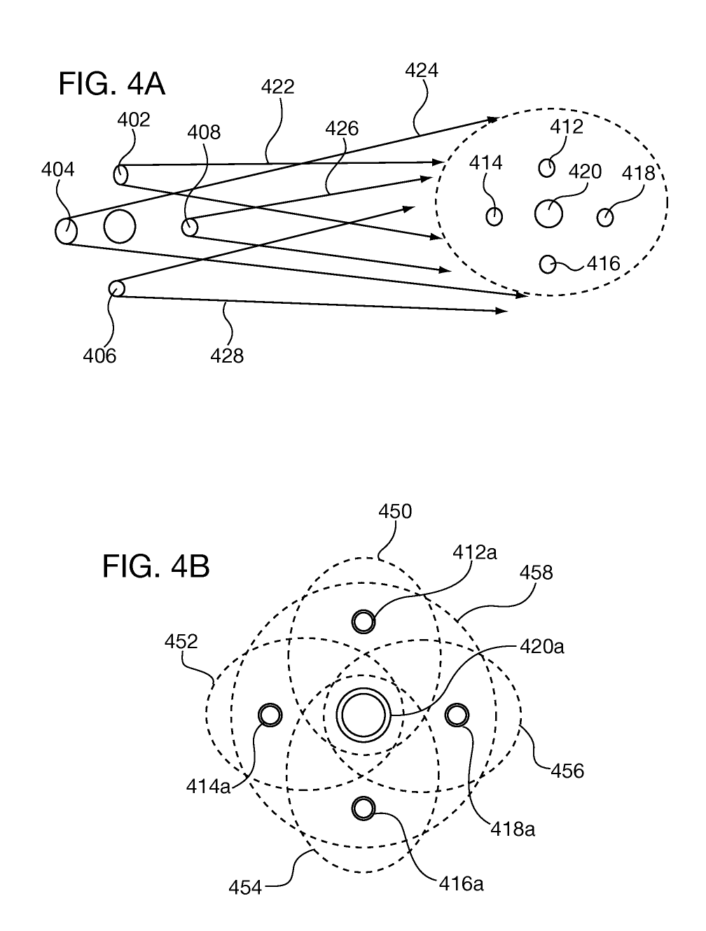

FIG. 4A shows example multiple divergence signal beams transmitted by a first FSO transceiver and the corresponding signal coverage at a second FSO transceiver. At the first FSO transceiver, on the transmit side, multiple transmitters 402, 404, 406, and 408 transmit multiple beams 422, 424, 426, and 428 to the receive side at the second FSO transceiver, resulting in a corresponding number of projection areas. Similarly, at the second FSO transceiver, receiver 420 is substantially located at the center of the collective areas of the projections while transmitters 414, 416, 418, and 420 may transmit optical beams in the reverse direction. Each of these beams may have a different rate of divergence to simultaneously increase projection area and increase beam density.

FIG. 4B shows an example projection of multiple divergence signal beams at a receiving end FSO transceiver. In one embodiment, projection areas 450, 452, 454, 456, and 458 substantially overlap so that any movement of the beams and/or receiver 420a relative to each other does not interrupt the receiving of the beams by receiver 420a. Transmitters 412a, 414a, 416a, and 418a may transmit optical beams and generate similar projections at the other FSO transmitter, as described above. In another embodiment multiple receivers may be used, for example, co-located next to some or each of the transmitters, to receive beam signals that may be missed by other receivers due to lateral movement of beams and/or receivers.

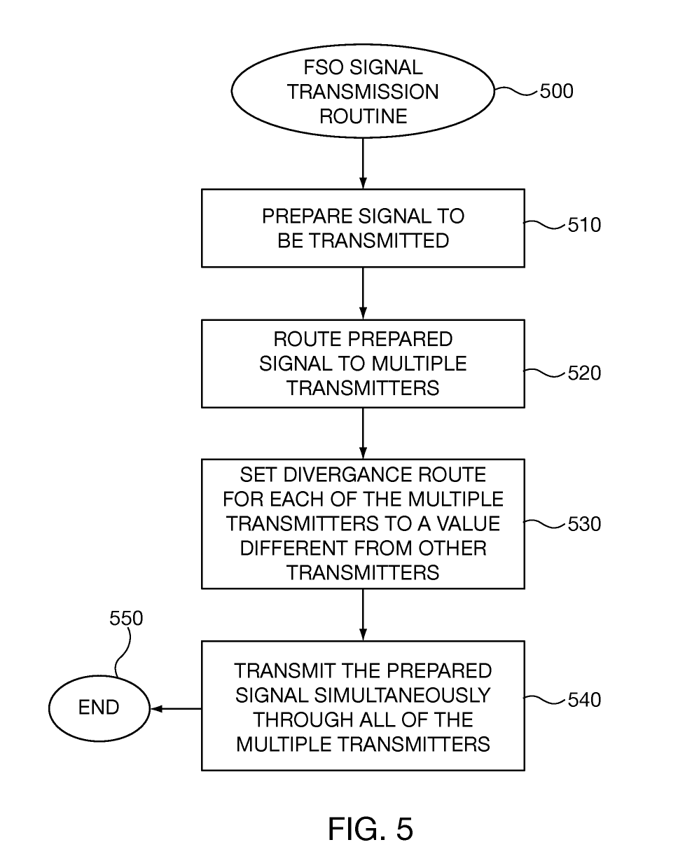

FIG. 5 is a flow diagram showing an example FSO signal transmission routine using multiple divergence rates. Process 500 proceeds to block 510 where an information signal prepared for optical encoding for transmission. In one embodiment, the information signal is transmitted over wired or wireless networks to and FSO transceiver where it is converted to an optical beam for optical transmission through air. In another embodiment, the information signal is generated locally and directly coupled with FSO for optical transmission.

At block 520, the optically encoded signal is routed to multiple FSO transmitters for simultaneous transmission. In one embodiment, two FSO transmitters are used, while in other embodiments, more than two transmitters are used.

At block 530, the divergence rate of each transmitter is set to a particular value. In one embodiment, the divergence rate of each transmitter is pre-set, for example, as part of an FSO initialization process. In another embodiment, the divergence rate of each transmitter may be set and/or changed dynamically during transmission based on real-time feedback. For example, as weather conditions change, such as wind blowing faster, strain gauges and/or vibration sensors attached to the building where FSO system is installed may detect larger sways in the building and send a feedback signal to some of the FSO transmitter to increase the transmission divergence rate for the respective transmitters.

In another embodiment, divergence rates for the transmitters may be set based on feedback from the receiving FSO transceiver. For example, if the beam is interrupted at the receiving FSO due to sway of a building on which the receiving FSO is installed, a feedback signal may be sent back to the transmitting FSO to increase the divergence rate of one or more of the transmitting FSO's transmitters.

In yet another embodiment, the divergence rates may be set periodically. For example, for an FSO transceiver having four transmitters, the divergence rate may be adjusted every few (example, 10-40) seconds. Multiple divergence rates used simultaneously may substantially increase FSO transceiver performance. As an example, if three of the beams are set to a divergence rate of 1 mrad and one at 4 mrad, the optical beam transmission distance and weather penetrations would go up, and the FSO transceiver mount rigidity requirement would go down, both of which may be critically important benefits for viable FSO performance.

The divergence rate may be set to a different value for each of the FSO transmitters. Alternatively, the divergence rate may be set to the same value for each transmitter included in a defined group of transmitters, which is different from the divergence rate set for other groups of transmitters.

At block 540, transmitters transmit the optical beam simultaneously at the different divergence rates set for each transmitter or group of transmitters to be received by another FSO transceiver.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A Free Space Optical (FSO) transceiver comprising:
a first transmitter configured to transmit a beam at a first divergence rate; and
a second transmitter configured to transmit the beam at a second divergence rate, wherein the first and the second divergence rates are different.

2. The FSO transceiver of claim 1, further comprising a plurality of receivers.

3. The FSO transceiver of claim 1, further comprising a plurality of other transmitters.

4. The FSO transceiver of claim 3, wherein the plurality of other transmitters are subdivided into a plurality of groups, each group having a different divergence rate.

5. The FSO transceiver of claim 1, further comprising an active tracking module.

6. A method of transmitting Free Space Optical (FSO) signals, the method comprising:
setting a first divergence rate of a first transmitter in a first FSO transceiver;
setting a second divergence rate of a second transmitter in the first FSO transceiver, wherein the second divergence rate is different from the first divergence rate; and
transmitting an optical beam simultaneously by the first and the second transmitters.

7. The method of claim 6, further comprising generating two overlapping beam projection areas at a second FSO transceiver.

8. The method of claim 7, wherein the two overlapping beam projection areas are determined based on a beam density.

9. The method of claim 7, wherein the two overlapping beam projection areas enclose a receiver at the second FSO transceiver.

10. The method of claim 7, wherein the first and the second divergence rates are adjusted based on feedback from the second FSO transceiver.

11. The method of claim 7, wherein the first and the second divergence rates are adjusted based on a sway of a building on which the second FSO transceiver is installed.

12. The method of claim 9, wherein at least one of the two overlapping beam projection areas keeps the receiver enclosed if the first and/or the second FSO transceivers move.

13. The method of claim 6, wherein the first and the second divergence rates are adjusted based on a sway of a building on which the first FSO transceiver is installed.

14. The method of claim 6, further comprising reducing a frequency of active tracking in the first FSO transceiver based on at least one of the first and the second divergence rates.

15. A method of transmitting Free Space Optical (FSO) signals, the method comprising:
transmitting a first beam at a first divergence rate to generate a first projection area at a receiving end; and
transmitting a second beam at a second divergence rate to generate a second projection area at the receiving end, wherein the first projection area overlaps with the second projection area.

16. The method of claim 15, further comprising adjusting the first divergence rate based on a feedback signal.

17. The method of claim 15, further comprising adjusting the first divergence rate periodically.

18. The method of claim 15, further comprising active tracking of the first and the second beams based on the first and the second divergence rates.

19. The method of claim 17, wherein a frequency of the active tracking is determined based on at least the first and the second divergence rates.

20. The method of claim 15, wherein a receiver of the first and the second beams is enclosed within at least one of the first and the second projection areas.
